(19) United States
(12) Patent Application Publication
(10) Pub. No.: US 2011/0298386 A1
(43) Pub. Date: Dec. 8, 2011

(54) LED LIGHTING FIXTURE WITH ONE SET OF INTENSITY OF LIGHT

(75) Inventor: Danilo CORRADI, Nibbiano (IT)

(73) Assignee: ARTEMIDE S.p.A., Milano (IT)

(21) Appl. No.: 13/083,236

(22) Filed: Apr. 8, 2011

(30) Foreign Application Priority Data
Apr. 9, 2010 (IT) MI2010A000596

(51) Int. Cl. H05B 37/02

(52) U.S. Cl. 315/224

(57) ABSTRACT

A LED lighting apparatus includes at least one LED lighting element, a control unit and a switching converter, for supplying the LED lighting element. A feedback circuit is connected between the LED lighting element and a ground line and co-operates with the switching converter for determining a LED current through LED lighting element. The feedback circuit has a first impedance in a first state, to which a non-zero first regulation value of the LED current corresponds, and a second impedance in a second state, to which a non-zero second regulation value of the LED current corresponds. The control unit is configured to cyclically switch the feedback circuit between the first state and the second state with a controllable duty-cycle.

### TECHNICAL FIELD

The present invention relates to a LED lighting apparatus with adjustable lighting intensity.

### BACKGROUND OF THE INVENTION

It is known that LED lighting devices normally use switching supplies which allow, among other functions, to regulate the output intensity according to the user's commands.

A regulation mode of proven efficacy contemplates the use of a double pulse width modulation (or PWM) control.

Switching supplies are based on a first high-frequency PWM control by means of which the current which flows through the LED lighting elements is maintained about a reference value. More in detail, in LED lighting apparatuses, the switching supply comprises a switch, normally a MOSFET, connected between an input supply line and the LED lighting elements, and a control circuit. An inductor, connected between the switch and the LED lighting elements, is charged when the switch is closed and is discharged through the LED lighting elements and a recirculation diode when the switch is open. The control circuit, high-frequency control signal PWM (generally higher than 1 MHz), alternatively opens and closes the switch according to a duty-cycle determined according to the current absorbed by the LED lighting elements and to a reference, so as to control the charging and discharging of the inductor. The current which flows through the lighting elements is thus maintained about a desired operative value.

In order to vary the lighting intensity, a second low-frequency PWM control is used (e.g. from 100 Hz to 1 kHz). A second PWM signal, e.g. supplied by an external control unit, alternatively enables and disables the switching of the switch according to a duty-cycle fixed by the user through a command. In practice, during a portion of each period (active phase or “on” phase), the switch is controlled as described above and switches at high frequency. During the remaining portion of the period (inactive phase or “off” phase) the switch is deactivated and remains open, regardless of the conditions of the LED lighting elements. Once the inductor is completely discharged, the passage of current crossing the LED lighting elements ceases and the LEDs are cut off. The average current crossing the LED lighting elements and thus the lighting intensity are determined by the duty-cycle of the second PWM signal and by the current operating value when the switch is enabled.

Although very simple and effective, the use of the double PWM control for regulating the output intensity of LED lighting devices has some serious limitations.

As mentioned, in particular, the LEDs are cut off when the switch is deactivated by the low-frequency PWM signal. The lighting of the LEDs during the subsequent cycle causes a current peak which is short lasting but has considerable width, and is in all cases much higher than the usual operating current of the active phases, in which the switch is enabled. The lighting peaks subject the LEDs to stress which, given the very high number of cycles, may be damaged over time. On the other hand, the frequency of the second PWM signal cannot be reduced beyond a given limit because this would produce a flickering perceivable by the human eye. Therefore, a consequence of the type of described control is the reduction of the life of the LED lighting elements.

### SUMMARY OF THE INVENTION

Thus, it is the object of the present invention to provide a LED lighting apparatus which allows to overcome the described limitations and, in particular, allows to extend the life of the LED lighting elements.

According to the present invention, a LED lighting apparatus as disclosed in claim 1 is provided.

### BRIEF DESCRIPTION OF THE DRAWINGS

The present invention will now be described with reference to the accompanying drawings, which illustrate a non-limitative embodiment thereof, in which:

FIG. 1 is a simplified circuit diagram of a LED lighting apparatus in accordance with an embodiment of the present invention;

FIG. 2 is a chart showing magnitudes related to the apparatus in FIG. 1;

FIG. 3 is a more detailed circuit diagram of a portion of the apparatus in FIG. 1; and

FIG. 4 is a simplified block chart of a LED lighting apparatus according to a different embodiment of the present invention.

### BEST MODE FOR CARRYING OUT THE INVENTION

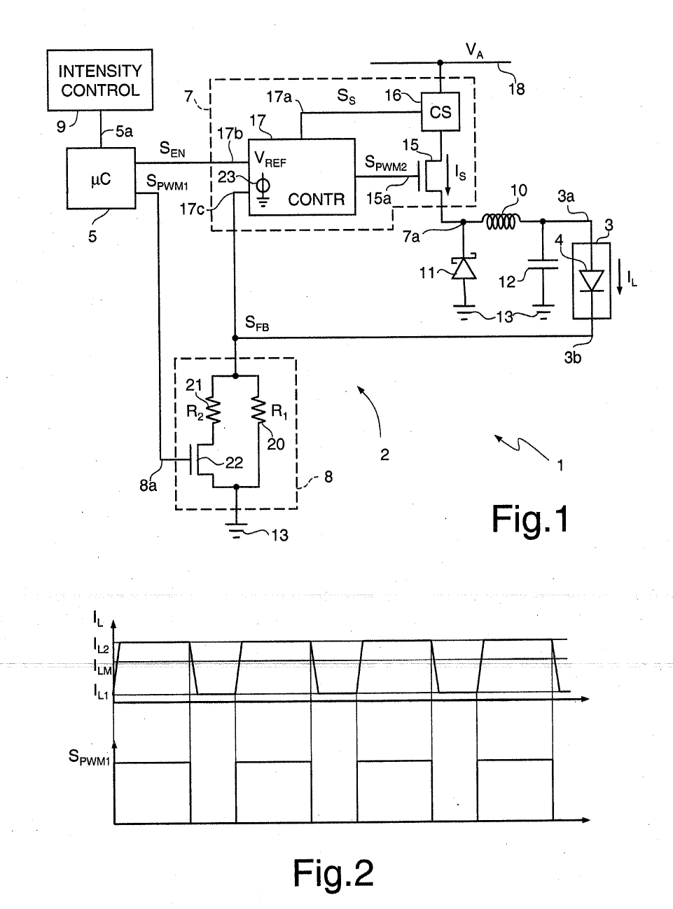

As shown in FIG. 1, a LED lighting apparatus 1 comprises a power supply 2 and at least one LED lighting module 3. The LED lighting module 3 comprises a plurality of LED sources 4 forming a matrix and coupled to the supply 2. For the sake of simplicity, FIG. 1 diagrammatically shows a single LED source 4.

The power supply 2 comprises a control unit 5, a switching converter 7, and a feedback circuit 8. Furthermore, an inductor 10, a recirculation diode 11 and a filter capacitor 12 are arranged between the converter 7 and the LED lighting module 3. The inductor 10 is connected between the output terminal 7a of the converter 7 and an anode terminal 3a of the LED lighting module 3; the recirculation diode 11 is connected between a ground line 13 and the output terminal 7a of the converter 7; and the filter capacitor 12 is connected between the ground line 13 and the anode terminal 3a of the LED lighting module 3.

The control unit 5, e.g. a microcontroller, provides an enabling signal EN to the converter 7 and a first control signal S_{PWM1} to a control terminal of the feedback circuit 8. As mentioned more in detail below, the first control signal S_{PWM1} is a low-frequency pulse width modulation signal (e.g. from 100 Hz and 1 kHz) and has a variable duty-cycle. In particular, the duty-cycle of the first control signal S_{PWM1} may be set by a manual control 9, coupled to a reference input 5a of the control unit 5.

The converter 7 is in Buck configuration and comprises a switch 15, which in the described embodiment is an N-channel MOSFET, a current sensor 16 and a control circuit 17.

The switch 15 has a first conduction terminal (drain) connected to a power line 18, on which a direct power voltage V_{A} is present and a second conduction terminal (source), which defines the output terminal 7a of the converter 7 and is connected to the LED lighting module 3 through the inductor 10. A control terminal 15a (gate) of the switch 15 is connected to an output of the control circuit 17 to receive a second control signal S_{PWM2}, as described below.

The current sensor 16 is arranged between the power line 18 and the first conduction terminal of the switch 15 and detects a switch current I_{S} which flows through the switch 15. An output of the current sensor 16 provides a detection signal S_{S}, indicative of the switch current I_{S}, to a detection input 17a of the control circuit 17.

The control circuit 17 has an enable input 17b, connected to a corresponding enabling terminal of the control unit 5, for receiving an enable signal S_{EN}; and a feedback input 17c, connected to a cathode terminal 3b of the LED lighting module 3 and to the feedback circuit 8 to receive a feedback signal S_{FB}.

The feedback circuit 8 is connected between the cathode terminal 3b of the LED lighting module 3 and the ground line 13 and determines the feedback signal S_{FB}, which is indicative of a LED current I_{L} flowing through the LED lighting module 3.

In the embodiment described here, the feedback circuit 8 comprises a first resistor 20, a second resistor 21 and a secondary switch 22 (herein an N-channel MOSFET), separate from the switch 15. Furthermore, the feedback circuit 8 has two states and is configured so that in one of the two states the LED current LED I_{L} flows through either the first resistor 20 or the second resistor 21, while in the other of the two states, the first resistor 20 and the second resistor 21 both receives a respective fraction of the LED current I_{L}.

The first resistor 20 has a first constant resistance value R₁ and is connected between the cathode terminal 3b of the LED lighting module 3 and the ground line 13. The second resistor 21 has a second constant resistance value R₂ and a terminal connected to the cathode terminal 3b of the LED lighting module 3. A further terminal of the second resistor 21 is selectively connectable to the ground line 13 through the secondary switch 22. A control terminal (gate) of the secondary switch 22 defines the control terminal 8a of the reference circuit 8 and is connected to a respective output of the control unit 5 to receive the first control signal S_{PWM1}.

The feedback circuit 8 is controlled by the control unit 5. In the first state, the secondary switch 22 is open and the impedance between the cathode terminal 3a of the LED lighting module 3 and the ground line 13 is determined by the first resistor only 20. The second resistor 21 is indeed excluded and does not receive current from the LED lighting module 3. In the second state, the secondary switch 22 is closed and the second resistor 21 is inserted in parallel to the first resistor 20. The impedance between the cathode terminal 3a of the LED lighting module 3 and the ground line 13 is thus smaller than in the first state.

Thus, given the same LED current I_{L} flowing through the LED lighting module 3, the feedback signal S_{FB} (voltage, in the described embodiment) is higher when the feedback circuit 8 is in the first state, with higher impedance.

In use, the feedback circuit 8 cooperates with the converter 7 to determine the LED current I_{L} through the LED lighting module 3. When the converter 7 is enabled by the control unit 5, the control circuit 17 sets the duty-cycle of the second high-frequency control signal S_{PWM2} so as to obtain an average value of the LED current I_{L} which is a function of an internal reference voltage V_{REF} (diagrammatically represented by a reference voltage generator 23) of the feedback signal S_{FB} and of the state of the feedback circuit 8.

More in detail, the control circuit 17 determines the duty-cycle of the second control signal S_{PWM2} according to the difference between the feedback signal S_{FB} and the inner reference voltage V_{REF}: if the feedback signal S_{FB} increases, the duty-cycle of the second control signal S_{PWM2} is reduced and, vice versa, if the feedback signal S_{FB} decreases, the duty-cycle of the second control signal S_{PWM2} is increased. When the stabilisation transients are over, the LED current I_{L} is stabilised about a regulation value.

When the feedback circuit 8 is in the first state, the feedback signal S_{FB}, increases more rapidly than in the second state. The LED current I_{L} is in fact set, in essence, by the inductor 10 and thus increases with the same rapidity, regardless of the state of the feedback circuit 8, which has however different impedances in the two states.

The switching condition of the switch 15 is thus reached more rapidly and with lower LED current I_{L} in the first state, and more slowly and with higher LED current I_{L} in the second state. The duty-cycle of the second control signal S_{PWM2} is influenced as a consequence and is lower in average when the feedback circuit 8 is in the first state. As shown in FIG. 2, as a consequence, the LED current I_{L} has a non-zero first regulation value I_{L1}, when the feedback circuit 8 is in the first state, and a second regulation value I_{L2}, higher than the first regulation value I_{L1}, when the feedback circuit 8 is in the second state.

The duty-cycle of the first low-frequency control signal S_{PWM1} which is set by the user through the manual control 9, determines the ratio between permanence times of the feedback circuit 8 in the first state and in the second state and thus the average value I_{LM} of the LED current I_{L}. In turn, the average value I_{LM} of the LED current I_{L} determines the output intensity of the LED lighting module 3.

Advantageously, the power supply 2 is made so that the LED current I_{L} is never zero and thus the LEDs 4 of the LED lighting module 3 always remain powered, without being cut off. The switch 15 is active and takes part in the high-frequency regulation also when the first control signal S_{PWM1} takes the feedback circuit 8 to the first state, to which the lower regulation value of the LED current I_{L} corresponds. Because LEDs 4 are conductive in all cases, the current peaks are greatly limited when the LED current I_{L} passes from the first regulation value I_{L1} to the second regulation value L_{L2}. The LED 4 are thus preserved from possible damage and their lifespan is extended.

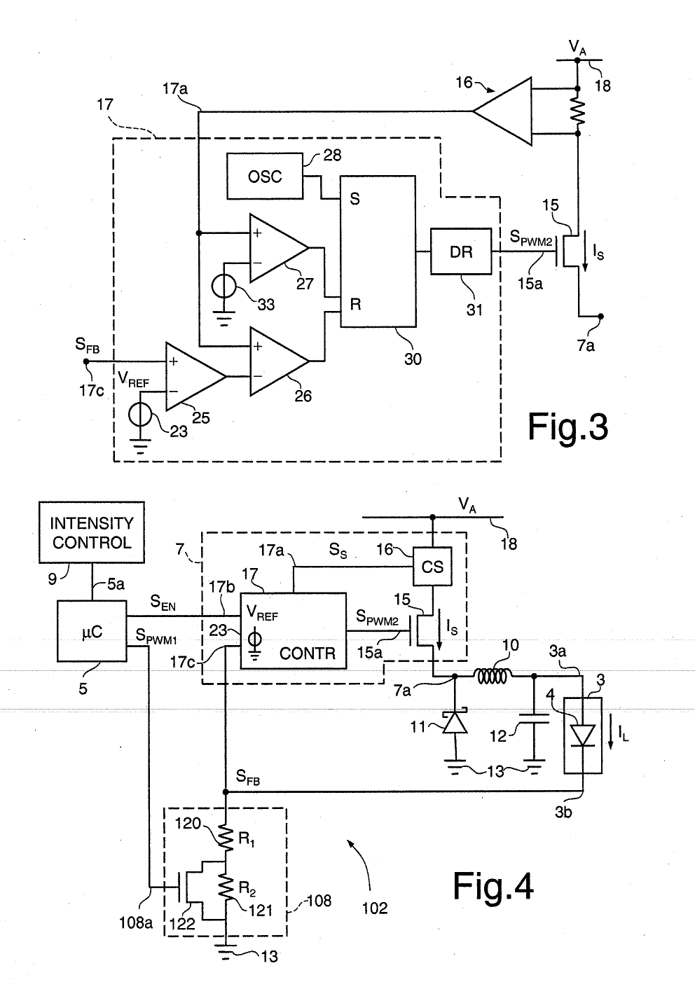

FIG. 3 shows an embodiment of the converter 7. In the described embodiment, the converter 7 comprises, in addition to the reference voltage generator 23, an error amplifier 25, a first comparator 26, a second comparator 27, an oscillator 28, a bistable circuit 30 and a driving circuit 31.

The error amplifier 25, of the integral type, has inputs respectively connected to the cathode terminal 3a of the LED lighting module 3 and to the reference voltage generator 23 for receiving the feedback signal S_{FB} and the reference voltage V_{REF} respectively. The output of the error amplifier 25 is connected to an input of the first comparator 26, a second input of which defines the detection terminal 7a of the converter 7 and receives the detection signal S_{S} from the current sensor 6. The second comparator 27 also receives the detection signal S_{S} and an input connected to a further reference voltage generator 33, which provides an end-of-cycle reference voltage V_{EC}. The outputs of the first comparator 26 and of the second comparator 27 are both connected (in OR) to a reset input of the bistable circuit 30. The set input of the bistable circuit 30 is connected to an output of the oscillator 28. Both set and reset inputs of the bistable circuit 30 respond to leading edges of the respective signals.

The driving circuit 31 is controlled by the bistable circuit 30 and provides the second control signal S_{PWM2} to the driving terminal 15a of the switch 15 to alternatively open and close the switch 15 itself. In detail, the driving circuit 31 closes the switch 15 when the output of the bistable circuit 30 is high; when instead the output of the bistable circuit 30 is low, the switch 15 is opened.

At the beginning of each cycle of the second control signal S_{PWM2}, the oscillator 28 takes the output of the bistable circuit 30 to high state and causes the closing of the switch 15, which starts conducting, making the LED current I_{L} grow.

The error comparator 25 integrates the difference between reference voltage V_{REF} and feedback signal S_{FB}, which represents the LED current I_{L}, and the first comparator 26 compares the result of the integration with the detection signal S_{S}. When the detection signal S_{S} exceeds the output of the error comparator 25, the first comparator 26 switches and takes the output of the bistable circuit 30 to the low state, causing the opening of the switch 15. If the LED current I_{L} is not sufficient in order for the detection signal S_{S} to exceed the output value of the error comparator 25 before the end of the cycle of the second control signal S_{PWM2}, the output of the bistable circuit 30 is taken to the low state by the second comparator 27, which switches when the reference signal S_{S} reaches the end-of-cycle reference voltage V_{EC}.

According to the embodiment of the invention shown in FIG. 4, in which parts equal to those already illustrated are designated by the same reference numerals, a lighting apparatus 100 comprises a power supply 102 and the LED lighting module 3, coupled thereto. The power supply 102 comprises, in turn, the control unit 5, the converter 7, the inductor 10, the recirculation diode 11 and the filter capacitor 12, as already described above and further more a feedback circuit 108.

The feedback circuit 108 comprises a first resistor 120, a second resistor 121 and a second switch 122, also in this case an N-channel MOSFET. Furthermore, the feedback circuit 108 has two states and is configured so that in one of the two states the LED current LED I_{L} flows through only one of the first resistor 120 and the second resistor 121, while in the other of the two states, the first resistor 120 and the second resistor 121 both receive a respective fraction of the LED current I_{L}.

The first resistor 120 and the second resistor 121 have respectively a first resistance value R₁ and a second resistance value R₂, which are constant and, with the secondary switch 122 open, are connected in series between the cathode terminal 3b of the LED lighting module LED 3 and the ground line 13. The second switch 122 has conduction terminals connected to respective terminals of one of the resistors 120, 121, here the second resistor 121. Furthermore, a control terminal (gate) of the secondary switch 22 defines the control terminal 108a of the reference circuit 108 and is connected to a respective output of the control unit 5 to receive the first control signal S_{PWM1}.

The feedback circuit 108 is controlled by the control unit 5. In the first state, the secondary switch 122 is open and the impedance between the cathode terminal 3a of the LED lighting module 3 and the ground line 13 is determined by the series of the first resistor 120 and of the second resistor 121. In the second state, the secondary switch 122 is closed and thus the second resistor 121 is excluded. The impedance between the cathode terminal 3a of the LED lighting module 3 and the ground line 13 is thus lower than in the first state.

It is finally apparent that changes and variations may be made to the apparatus described, without departing from the scope of the present invention, as defined in the appended claims.

The switching converter, in particular, may be of different type than that described. For example, it is possible to use a variable frequency switching converter. In this case, the active step (the “on” step) of the switch of the converter starts when the detected LED current drops under a threshold and has fixed duration, controlled by a first counter. The switch of the converter switches at the end of the active phase. The active phase has minimum duration, determined by a second counter and is possibly prolonged if, once the minimum duration has elapsed, the LED current is still higher than the threshold. In this case, the cycles of the high frequency control signal have variable duration.

It is further apparent that either the first resistor or the second resistor may be excluded to modify the impedance of the feedback circuit. In limit conditions, both the first resistor and the second resistor could be provided with respective switches. In this manner, both may be turned on and off, obtaining greater control flexibility. Possibly, the first resistor and the second resistor, with respective separate resistance values, may be alternatively connected in series to the LED lighting element, one in the first state and the other in the second state.

1. Lighting apparatus comprising:
at least one LED lighting element;
a control unit;
a switching converter, having a supply input, connectable to a supply line for receiving an input supply voltage (V_{A}), and an output for supplying the LED lighting element;
a feedback circuit, connected between a terminal of the LED lighting element and a constant potential line and co-operating with the switching converter for determining a LED current (I_{L}) through LED lighting element;
characterized in that the feedback circuit has a first impedance (R₁) in a first state, to which a non-zero first regulation value (I_{L1}) of the LED current (I_{L}) corresponds, and a second impedance (R₂) in a second state, to which a non-zero second regulation value (I_{L2}) of the LED current (I_{L}) corresponds, and wherein the control unit is configured to cyclically switch the feedback circuit between the first state and the second state with a controllable duty-cycle.

2. Apparatus according to claim 1, wherein the feedback circuit comprises a first resistive element and a second resistive element, connected between a cathode terminal of the LED lighting element and the constant voltage line, and a first switch, separate from the first resistive element and from the second resistive element and controlled by the control unit to selectively exclude either the first resistive element or the second resistive element in either the first or the second state.

3. Apparatus according to claim 2, wherein the feedback circuit is configured so that in one of the first state and the second state the LED current (I_{L}) flows through only one of the first resistive element and the second resistive element.

4. Apparatus according to claim 3, wherein in the other of the first state and the second state, the first resistive element and the second resistive element both receive at least one respective fraction of the LED current (I_{L}).

5. Apparatus according to claim 2, wherein the feedback circuit is configured so that the first resistive element receives at least a respective fraction of the LED current (I_{L}) in at least one of the first state and the second state and the second resistive element receives at least a respective fraction of the LED current (I_{L}) in at least one of the first state and the second state.

6. Apparatus according to claim 2, wherein the first resistive element and the second resistive element are resistors having constant respective resistances (R₁, R₂).

7. Apparatus according to claim 2, wherein the first resistive element is connected between the cathode terminal of the LED lighting element and the constant voltage line, and the second resistive element is selectively connectable in parallel to the first resistive element through the first switch.

8. Apparatus according to claim 2, wherein the first resistor and the second resistor are connected in series between the cathode terminal of the LED lighting element and the constant voltage line, when the first switch is open, and the first switch has conduction terminals connected to respective terminals of one between the first resistor and the second resistor.

9. Apparatus according to claim 2, wherein the switching converter comprises:
a second switch, separate from the first switch, having a first conduction terminal, connectable to the supply line, and a second conduction terminal, coupled to an anode terminal of the LED lighting element; and
a control circuit, having a feedback input, connected to the feedback circuit for receiving a feedback signal (S_{FB}), and an output terminal, coupled to a control terminal of the second switch;
and wherein the control circuit is configured to control the second switch on the basis of the feedback signal (S_{FB}) and of a reference signal (V_{REF}).

10. Apparatus according to claim 9, wherein the control circuit is configured to provide the control terminal of the second switch with a switching signal (S_{PWM2}) having a duty-cycle and to set the duty-cycle of the switching signal (S_{PWM2}) on the basis of the feedback signal (S_{FB}) and of the reference signal (V_{REF}).

11. Apparatus according to claim 1, wherein the control unit is configured to provide to a control terminal of the feedback circuit a pulse-width-modulation control signal (S_{PWM1}) and the feedback circuit is configured to switch between the first state and the second state in response to the pulse-width-modulation control signal (S_{PWM1}).
